(19) United States
(12) Patent Application Publication
(10) Pub. No.: US 2006/0289674 A1
(43) Pub. Date: Dec. 28, 2006

(54) Device and system for dispensing fluids into the atmosphere

(75) Inventors: Joel A. Kubby, Rochester, NY (US); Nancy Y. Jia, Webster, NY (US); Edward Francis, Pittsford, NY (US); Robert M. Duffner, Penfield, NY (US); Jun Ma, Penfield, NY (US); Cathie J. Burke, Rochester, NY (US); James C. Diehl, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/510,944

(22) Filed: Aug. 28, 2006

Related U.S. Application Data
(62) Division of application No. 10/732,724, filed on Dec. 10, 2003.

(51) Int. Cl. B05B 1/08

(52) U.S. Cl. 239/102.2

(57) ABSTRACT

A fluid dispensing device comprises one or more micromechanical fluid dispensing mechanisms arranged to dispense fluids into the atmosphere. The fluids include any of a perfume, pheromone, fragrance, disinfectant, moisturizer, humectant, miticide, fumigant, deodorizer, sanitizing agent and insecticide. A dispenser controller communicates with the fluid micromechanical dispensing mechanisms to selectively activate the fluid micromechanical dispensing mechanisms. Optionally, the fluid dispensing device includes a sensor to detect the airborne concentration of fluids that are dispersed in the atmosphere. Optionally, one or more fluid dispensing devices may be arranged to form a system, perhaps including a system sensor and a system controller.

### CROSS-REFERENCE TO RELATED APPLICATIONS

In accordance with the provisions of 35 U.S.C. section 121, this is a divisional application of its commonly-assigned parent application Ser. No. 10/732,724 filed 10 Dec. 2003 by the same inventors hereof, now pending. The disclosure of the prior parent application is totally incorporated herein by reference. This divisional application claims the priority benefit of the prior parent application under the provisions of 35 U.S.C. sections 120 and 121. This divisional application is being filed in response to a restriction requirement in the prior parent application.

### INCORPORATION BY REFERENCE OF OTHER U.S. PATENTS

The disclosures of the following twenty-two (22) U.S. patents are hereby incorporated by reference, verbatim, and with the same effect as though the same disclosures were fully and completely set forth herein:

Carole C. Barron et al., “Chemical-mechanical polishing of recessed microelectromechanical devices,” U.S. Pat. No. 5,919,548;

Carole C. Barron et al., “Method for integrating microelectromechanical devices with electronic circuitry,” U.S. Pat. No. 5,963,788;

Edward M. Carrese et al., “Ink tank with securing means and seal,” U.S. Pat. No. 6,390,615;

Steven T. Cho, “Microfluidic valve and system therefor,” U.S. Pat. No. 6,561,224;

Charles P. Coleman et al., “Method of fabricating a fluid drop ejector,” U.S. Pat. No. 6,127,198;

Charles P. Coleman et al., “Fluid drop ejector,” U.S. Pat. No. 6,318,841 B1;

Anthony J. Fariono et al., “Method for photolithographic definition of recessed features on a semiconductor wafer utilizing auto-focusing alignment,” U.S. Pat. No. 5,783,340;

Frank C. Genovese et al., “Magnetically actuated ink jet printing device,” U.S. Pat. No. 6,234,608 B1;

Arthur M. Gooray et al., “Magnetic drive systems and methods for a micromachined fluid ejector,” U.S. Pat. No. 6,350,015 B1;

Arthur M. Gooray et al., “Micromachined fluid ejector systems and methods,” U.S. Pat. No. 6,367,915 B1;

Arthur M. Gooray et al., “Fluid ejection systems and methods with secondary dielectric fluid,” U.S. Pat. No. 6,406,130 B1;

Arthur M. Gooray et al., “Bi-directional fluid ejection system and methods,” U.S. Pat. No. 6,409,311 B1;

Arthur M. Gooray et al., “Micromachined fluid ejector systems and methods having improved response characteristics,” U.S. Pat. No. 6,416,169 B1;

Arthur M. Gooray et al., “Electronic drive systems and method,” U.S. Pat. No. 6,419,315 B1;

Joel A. Kubby et al., “Micro-electro-mechanical fluid ejector and method of operating same,” U.S. Pat. No. 6,357,865 B1;

Nathan S. Lewis et al., “Sensor array for detecting analytes in fluids,” U.S. Pat. No. 5,571,401;

Edward J. Martens III et al., “Delivery system for dispensing volatiles,” U.S. Pat. No. 6,378,780;

Stephen Montague et al., “Method for integrating microelectromechanical devices with electronic circuitry,” U.S. Pat. No. 5,798,283;

Robert D. Nasby et al., “Use of chemical mechanical polishing in micromachining,” U.S. Pat. No. 5,804,084;

Eric Peeters et al., “Print head for use in a ballistic aerosol marking apparatus,” U.S. Pat. No. 6,116,718;

Eric Peeters et al., “Ballistic aerosol marking apparatus for marking with a liquid material,” U.S. Pat. No. 6,328,409; and

Kia Silverbrook, “Method of manufacture of a thermally actuated ink jet including a tapered heater element,” U.S. Pat. No. 6,180,427.

### BACKGROUND OF THE INVENTION

There is a need to control air quality to improve the human experience associated with human interaction with airborne materials such as perfumes, pheromones, moisturizers, humectants, miticides, deodorizers, disinfectants, sanitizing agents, insecticides and the like. While mechanisms for dispensing airborne materials are well-known, there are several problems associated with current devices and systems for dispensing materials into the atmosphere.

Current devices and systems do not provide the desired degree of control and flexibility with respect to the amount, time and type of material that is dispensed.

It is desirable to be able to provide this capability at low cost, with a device or system that is compact in size, operates with a large range of materials, and that can be configured to selectively dispense one or more materials from a set of materials.

Therefore, there is a need for improved devices and systems for dispensing materials into the atmosphere.

### SUMMARY OF THE INVENTION

In a first aspect of the invention, there is described a micromechanical dispensing device to dispense one or more fluids into an atmosphere, the micromechanical dispensing device comprising one or more micromechanical dispensing mechanisms, each micromechanical dispensing mechanism of the one or more micromechanical dispensing mechanisms fluidly connected to a corresponding fluid reservoir; the micromechanical dispensing device further comprising a micromechanical dispensing device controller, the micromechanical dispensing device controller arranged to communicate with each micromechanical dispensing mechanism of the one or more micromechanical dispensing mechanisms.

In a second aspect of the invention, there is described a system to dispense a plurality of fluids into an atmosphere, the system comprising a micromechanical dispensing device, the micromechanical dispensing device comprising one or more micromechanical dispensing mechanisms, each micromechanical dispensing mechanism of the one or more micromechanical dispensing mechanisms fluidly connected to a corresponding fluid reservoir; the micromechanical dispensing device further comprising a micromechanical dispensing device controller, the micromechanical dispensing device controller arranged to communicate with each micromechanical dispensing mechanism of the one or more micromechanical dispensing mechanisms; the system further comprising at least one other dispensing device, and a system controller, the system controller arranged to communicate with the micromechanical dispensing device and with each of the at least one other dispensing devices.

In a third aspect of the invention, there is described a micromechanical dispensing device to dispense a plurality of fluids into an atmosphere, the micromechanical dispensing device comprising a plurality of micromechanical dispensing mechanisms, each micromechanical dispensing mechanism of the plurality of micromechanical dispensing mechanisms fluidly connected to a corresponding fluid reservoir; the micromechanical dispensing device further comprising a micromechanical dispensing device controller, the micromechanical dispensing device controller arranged to communicate with each micromechanical dispensing mechanism of the plurality of micromechanical dispensing mechanisms.

In a fourth aspect of the invention, there is described a system to dispense a plurality of fluids into an atmosphere, the system comprising a micromechanical dispensing device, the micromechanical dispensing device comprising a plurality of micromechanical dispensing mechanisms, each micromechanical dispensing mechanism of the plurality of micromechanical dispensing mechanisms fluidly connected to a corresponding fluid reservoir; the micromechanical dispensing device further comprising a micromechanical dispensing device controller, the micromechanical dispensing device controller arranged to communicate with each micromechanical dispensing mechanism of the plurality of micromechanical dispensing mechanisms; and the system further comprising a system controller, the system controller arranged to communicate with the micromechanical dispensing device.

In a fifth aspect of the invention, there is described a micromechanical dispensing device to dispense one or more fluids into an atmosphere, the micromechanical dispensing device comprising a micromechanical dispensing mechanism, the micromechanical dispensing mechanism fluidly connected to a plurality of fluid reservoirs; and further comprising a valve, the valve arranged to selectively couple each fluid reservoir of the plurality of fluid reservoirs to the micromechanical dispensing mechanism; and, the micromechanical dispensing device further comprising a micromechanical dispensing device controller, the micromechanical dispensing device controller arranged to communicate with the micromechanical dispensing mechanism and the valve.

In a sixth aspect of the invention, there is described a micromechanical dispensing device to dispense a fluid into an atmosphere the micromechanical dispensing device comprising a plurality of micromechanical dispensing mechanisms, the plurality of micromechanical dispensing mechanisms fluidly connected to a fluid reservoir; and, the micromechanical dispensing device further comprising a micromechanical dispensing device controller, the micromechanical dispensing device controller arranged to communicate with the plurality of micromechanical dispensing mechanisms.

### BRIEF DESCRIPTION OF THE SEVERAL VIEWS OF THE DRAWING

FIG. 1 depicts a known dispensing device for dispensing a fluid into an atmosphere.

FIG. 2 depicts one embodiment of a micromechanical dispensing device 200 for dispensing one or more fluids into the atmosphere, in accordance with the invention.

FIG. 3 depicts one embodiment of a system 300 for dispensing one or more fluids into the atmosphere, in accordance with the invention. As shown, the system 300 includes at least one FIG. 2 micromechanical dispensing device 200.

FIG. 4 depicts another embodiment of a micromechanical dispensing device 400 for dispensing one or more fluids into the atmosphere, in accordance with the invention.

FIG. 5 depicts another embodiment of a system 500 for dispensing one or more fluids into the atmosphere, in accordance with the invention. As shown, the system 500 includes at least one FIG. 4 micromechanical dispensing device 400.

FIG. 6 depicts a further embodiment of a micromechanical dispensing device 600 for dispensing one or more fluids into the atmosphere, in accordance with the invention.

FIG. 7 depicts still another embodiment of a micromechanical dispensing device 700 for dispensing one or more fluids into the atmosphere, in accordance with the invention.

### DETAILED DESCRIPTION OF THE INVENTION

Briefly, a fluid dispensing device comprises one or more micromechanical fluid dispensing mechanisms arranged to dispense fluids into the atmosphere. The fluids include any of a perfume, pheromone, fragrance, disinfectant, moisturizer, humectant, miticide, fumigant, deodorizer, sanitizing agent and insecticide. A dispenser controller communicates with the fluid micromechanical dispensing mechanisms to selectively activate the fluid micromechanical dispensing mechanisms. Optionally, the fluid dispensing device includes a sensor to detect the airborne concentration of fluids that are dispersed in the atmosphere. Optionally, one or more fluid dispensing devices may be arranged to form a system, perhaps including a system sensor and a system controller.

Referring now to FIG. 2, there is depicted one embodiment of a micromechanical dispensing device 200 for dispensing one or more fluids into the atmosphere, in accordance with the present invention.

As shown, the micromechanical dispensing device 200 comprises one or more micromechanical dispensing mechanisms 210, 212 fluidly connected to fluid reservoirs 220, 222. By a micromechanical dispensing mechanism, we mean a mechanism of the type and character as further discussed below, formed using micromachining and etching techniques, typically with a silicon based device, such micromechanical devices also often referred to as microelectromechanical devices.

As shown, the micromechanical dispensing mechanisms 210, 212 possess inlets 213, 214 for receiving a fluid to be dispensed. The inlets 213, 214 are fluidly connected to channels 254, 255 that conduct fluid from the fluid reservoirs 220, 222 to the micromechanical dispensing mechanisms 210, 212. The fluid reservoirs 220, 222 are removably fluidly coupled to ports 226, 228 by means of the ports 223, 225 of fluid reservoirs 220, 222.

By way of example only, in one embodiment the fluid reservoirs 220, 222 are similar or identical to the fluid reservoir described in U.S. Pat. No. 6,390,615 to Edward M. Carrese et al., which patent is incorporated by reference herein, and which patent is hereinafter referred to as the “Carrese patent.”

As shown, in one embodiment, the micromechanical dispensing device 200 comprises one or more check valves 251, 253 situated between fluid reservoirs 220, 222 and the corresponding fluid reservoir ports 223, 225.

Still referring to FIG. 2, in one embodiment, one or more of the fluid reservoirs 220, 222 contains a perfume, the corresponding micromechanical dispensing mechanisms 210, 212 dispensing the perfume. In another embodiment, one or more of the fluid reservoirs 220, 222 contains a disinfectant, the corresponding micromechanical dispensing mechanisms 210, 212 dispensing the disinfectant. In yet another embodiment, one or more of the fluid reservoirs 22Q, 222 contains a sanitizing agent, the corresponding micromechanical dispensing mechanisms 210, 212 dispensing the sanitizing agent. In another embodiment, one or more of the fluid reservoirs 220, 222 contains a pheromone, the corresponding micromechanical dispensing mechanisms 210, 212 dispensing the pheromone. In a further embodiment, one or more of the fluid reservoirs 220, 222 contains an insecticide, the corresponding micromechanical dispensing mechanisms 210, 212 dispensing the insecticide. In a further embodiment, one or more of the fluid reservoirs 220, 222 contains a miticide, the corresponding micromechanical dispensing mechanisms 210, 212 dispensing the miticide; a miticide being one of the well-known materials to kill mites. In a further embodiment, one or more of the fluid reservoirs 220, 222 contains a humectant, the corresponding micromechanical dispensing mechanisms 210, 212 dispensing the humectant. As will be appreciated by one skilled in the art, there are numerous fluids suitable for use with the micromechanical dispensing device 200 to control the quality or other aspects of the atmosphere for aesthetic, hygienic or mood enhancing effects.

Referring still to FIG. 2, the micromechanical dispensing mechanisms 210, 212 are arranged for communication with the micromechanical dispensing device controller 240 by means of communication path or link 231. The micromechanical dispensing device controller 240 actuates the micromechanical dispensing mechanisms 210, 212 by means of control signals transmitted on communication path 231. The micromechanical dispensing device controller 240 may receive external signals for programmatic control by means of control interface 234 coupled to the micromechanical device controller 240 by means of communication path 233.

The micromechanical dispensing device controller 240 may comprise any of a number of well-known control and programming electronic circuits or devices well-known to those skilled in the art. By way of example only, in various embodiments the micromechanical dispensing device controller 240 may comprise an ASIC, a PGA, a PROM, an EPROM, an EEPROM, an FPGA, or a discrete circuit. In one embodiment the micromechanical dispensing device controller 240 is comprised of electronic circuitry that is a part of the same micromechanical structure comprising one or more of the micromechanical dispensing mechanisms 210, 212.

Still referring to FIG. 2, in one embodiment, the micromechanical dispensing device 200 further comprises optional sensor 260 responsive to the concentration of an atmospheric substance 280. In a further embodiment the optional sensor 260 is responsive to the concentration of an atmospheric substance 280 corresponding to a fluid 271, 273 that has been dispensed by the micromechanical dispensing device 200.

Optionally, sensor 260 may be operatively connected to the micromechanical dispensing device controller 240 by means of communication path 232. In one embodiment, the optional sensor 260 communicates a sensor signal 235 based on the airborne concentration of an atmospheric substance 280 by means of communication path 232. In a further embodiment the micromechanical dispensing device controller, responsive to the sensor signal 235 actuates one or more of the micromechanical dispensing mechanisms 210, 212.

In another embodiment, the optional sensor 260 communicates a sensor signal 263 based on the airborne concentration of an atmospheric substance 280 by means of communication path 261 connected to the sensor communication interface 262.

Sensors responsive to the airborne concentration of substances in the atmosphere are well-known to those skilled in the art. By way of example only, in one embodiment the optional sensor 260 comprises a device similar or identical to the sensor described in U.S. Pat. No. 5,571,401 to Nathan S. Lewis et al., which patent is incorporated by reference herein, and which patent is hereinafter referred to as the “Lewis patent” or simply “Lewis”.

Still referring to FIG. 2, in one embodiment, the micromechanical dispensing device 200 comprises a dispersion pad 290 positioned to receive a fluid dispensed by one or more of the micromechanical dispensing mechanism 210, 212.

In various embodiments the dispersion pad 290 may comprise any natural or synthetic material or polymer, fiber or strand, either singular or woven, twisted, braided, bundled, molded or shaped in a manner that transports fluid or vapors by capillary action or that can serve as a support medium for the fluid or vapors.

By way of example only, the dispersion pad 290 may comprise porous ceramics;

celluloseic fibers such as flax, cotton, or wood; protein based fibers such as wool or other animal hides; or, synthetics such as nylon, polyester or other olefinic polymers or fibers.

The dispersion pad 290 is separated from the micromechanical dispensing device 200 by a gap 291-291′.

In one embodiment of the micromechanical dispensing device 200, the gap 291-291′ is minimized to achieve substantially zero distance, providing intimate contact between the dispersion pad 290 and the micromechanical dispensing device 200.

Additionally depicted in FIG. 2 is an optional orifice plate 295, further comprising an orifice 296. The optional orifice plate 295 is arranged such that fluid dispensed by at least one of the micromechanical dispensing mechanism 210, 212 is further dispensed through the orifice 296.

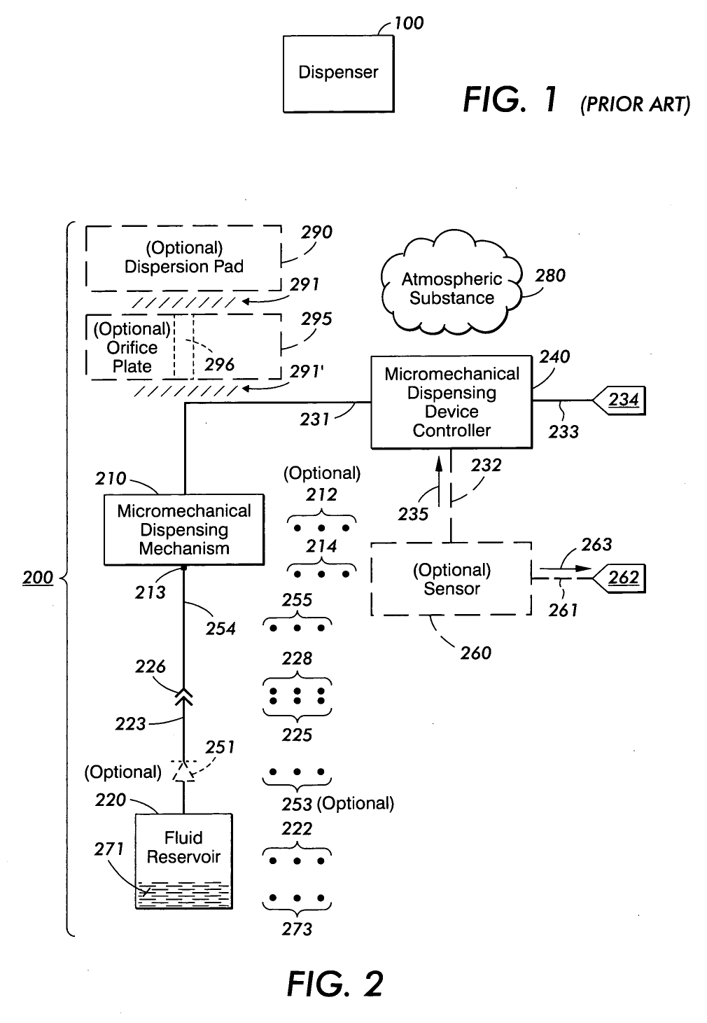

In one embodiment, the optional orifice plate 295 is similar or identical to the orifice plate containing an orifice as depicted in FIG. 1 and described from col. 3, I. 57 to col. 4, I. 54 of U.S. Pat. No. 6,378,780 to Edward J. Martens III et al., which patent is incorporated by reference herein, and which patent is hereinafter referred to as the “Martens patent” or simply as “Martens.”

Referring still to FIG. 2, several embodiments of the micromechanical dispensing mechanisms 210, 212 are now described in accordance with the current invention.

In one embodiment, one or more of the micromechanical dispensing mechanisms 210, 212 comprises electrostatically-driven membranes. In one embodiment, for example, one or more of the present micromechanical dispensing mechanisms 210, 212 comprises a membrane that is similar or identical to the electrostatically-actuated diaphragm 10 of the fluid ejector 100 as described and depicted in the foregoing U.S. Pat. No. 6,357,865 to Joel A. Kubby et al., which patent is incorporated herein by reference, and which patent is hereinafter referred to as the “Kubby patent” or simply “Kubby”.

Referring now to the Kubby patent, FIG. 1 discloses a micro-electromechanical fluid ejector 100 fabricated in a standard polysilicon surface micromachining process. As Kubby depicts in FIG. 1 and describes from col. 2, I. 65 to col. 3, I. 21, the fluid drop ejector 100 comprises a substrate 20, a silicon wafer, an insulator 30, a thin film of silicon nitride, Si₃N₄, a conductor 40, acting as the counterelectrode, made of metal or a doped semiconductor such as polysilicon, and a membrane 50, made from polysilicon as is typically used in a surface micromachining process. The fluid ejector 100 also comprises a nipple 52.

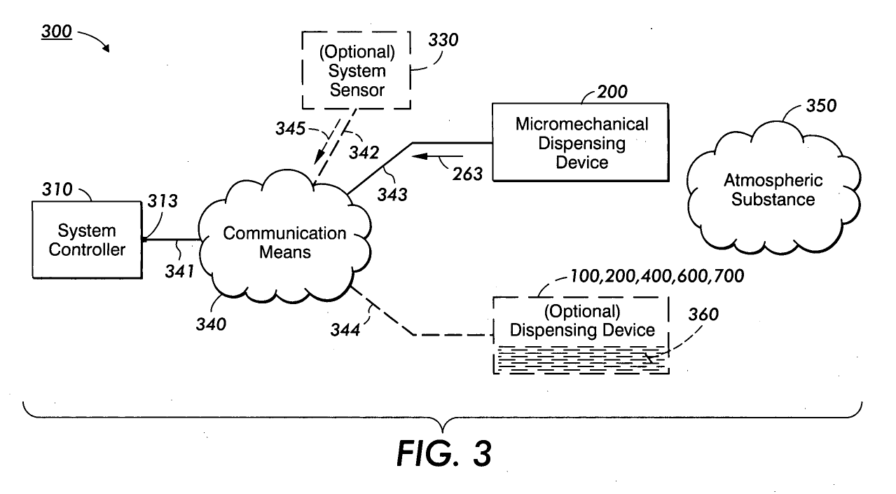

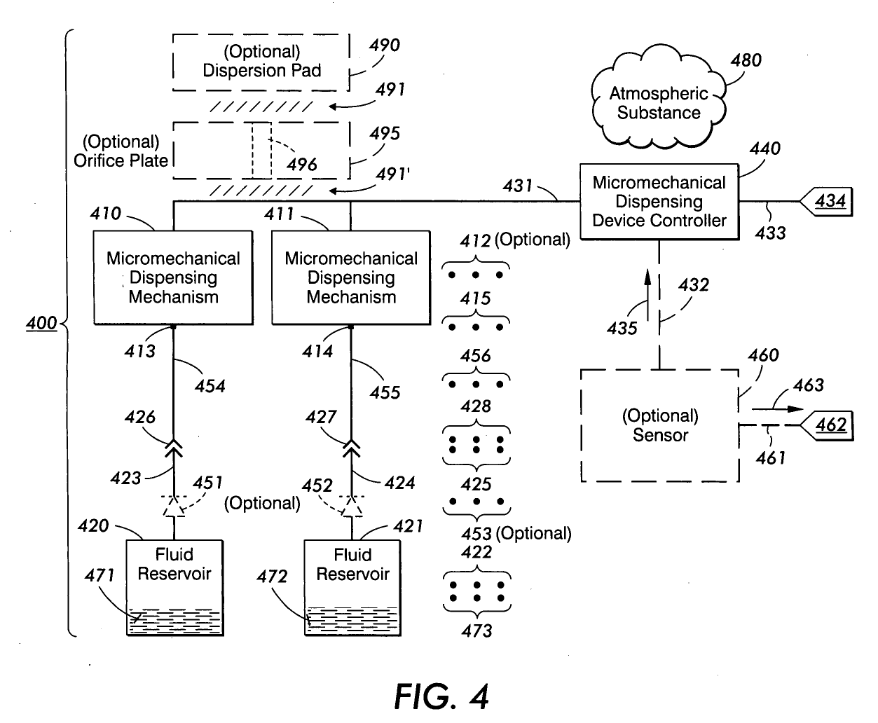

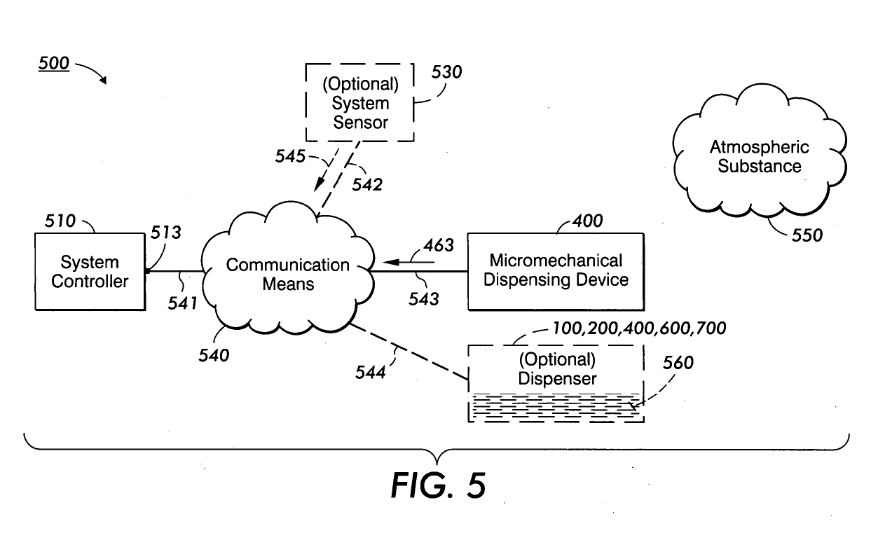

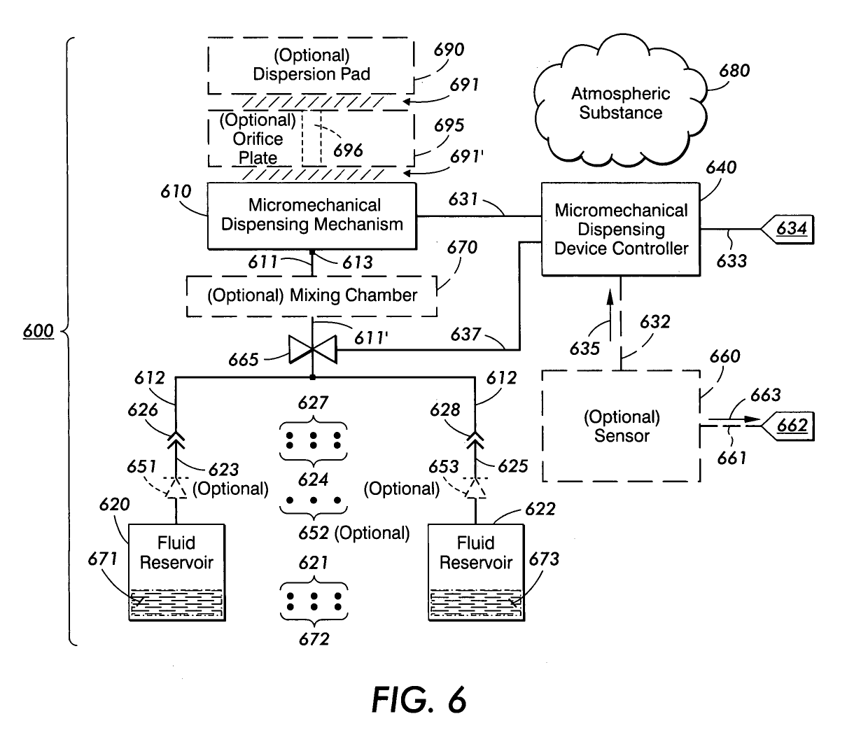

Still referring to the Kubby patent, the operation of the micromechanical dispensing mechanism 100 is described from col. 2, I. 65 to col. 4, I. 27. As described therein, a power source, element P, shown in FIG. 1, is applied between the membrane 10 and the conductor 40 to cause displacement of the membrane 10. Kubby's FIG. 2 shows a cross-section of the displaced membrane 10. As shown in Kubby's FIG. 4, displacement of the membrane 10 toward the conductor 40 increases the volume of the chamber 70 formed by the membrane 10 enclosed by orifice plate 60. Fluid is thus drawn into the chamber from a fluid reservoir, as described in Kubby at col. 3, II. 45-46. As shown in FIG. 3, the nipple 52 serves to limit the displacement of the membrane toward the conductor 40. As shown in Kubby's FIGS. 5-6, as the voltage between the conductor and the membrane is relaxed, the membrane returns to its initial position, thus creating an increased fluid pressure which ejects a drop of fluid 72.

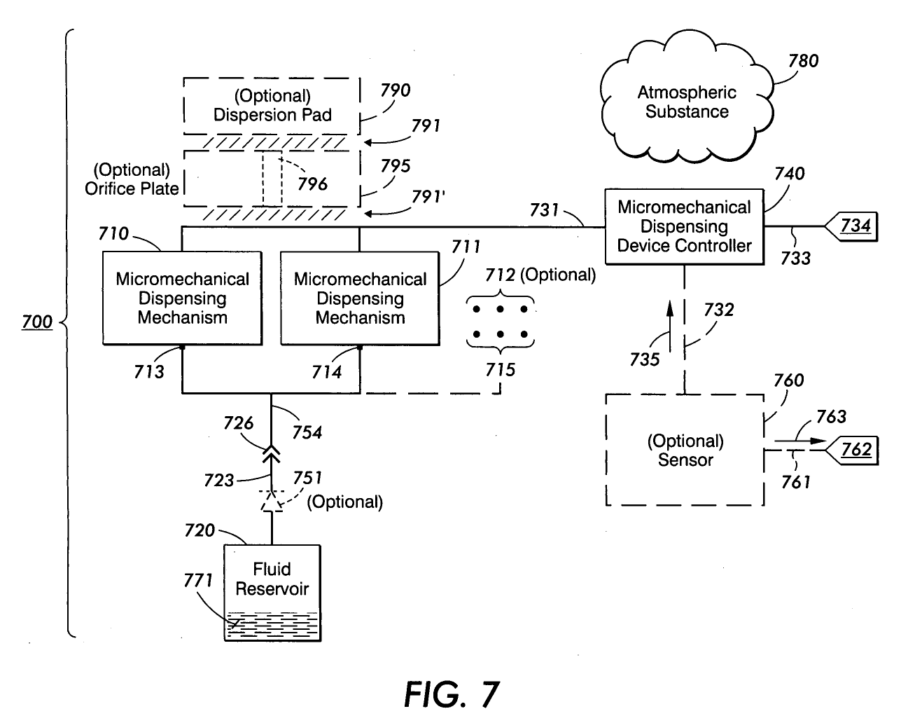

Still referring to the Kubby patent, the process for forming the micromechanical dispensing mechanism 100 is described from col. 6, I. 4 to col. 7, I. 24 and depicted in FIGS. 7-14.

Referring again to the present FIG. 2, in a further embodiment, one or more of the micromechanical dispensing mechanisms 210, 212 comprises an electrostatically-actuated piston. In one embodiment, for example, one or more of the present micromechanical dispensing mechanisms 210, 212 comprises a piston that is similar or identical to the electrostatically-actuated piston 110 of the fluid ejector 100 as described in the foregoing U.S. Pat. No. 6,367,915 to Arthur M. Gooray et al., which patent is incorporated by reference herein, and which patent is hereinafter referred to as the “Gooray '915 patent.”

Referring now to the Gooray '915 patent, FIG. 1 discloses a micromechanical fluid ejector 100 fabricated using the SUMMiT processes or other suitable micromachining processes. As described in the Gooray '915 patent at col. 1, II. 14-21, the SUMMiT processes are described in various U.S. patents, including foregoing U.S. Pat. Nos. 5,783,340; 5,798,283; 5,804,084; 5,919,548; 5,963,788 and 6,053,208, each of the foregoing patents being incorporated by reference herein. The Gooray '915 patent depicts in FIG. 1 and describes at col. 4, II. 35-65 the fluid drop ejector 100 comprising a movable piston structure 110, a stationary face plate 130, a fluid chamber 120 and a substrate 150. As shown in the aforementioned FIG. 1, the piston structure 110 may be resiliently mounted on the substrate 150 by one or more spring elements 114. The stationary face plate 130 further includes a nozzle hole 132 through which a fluid drop is ejected.

Still referring to the Gooray '915 patent, in one exemplary embodiment, the piston structure 110 moves towards the faceplate 130 due to electrostatic attraction between the piston structure 110 and the faceplate 130, ejecting fluid through nozzle hole 132, as described at col. 2, II. 51-54. Further embodiments of an electrostatically-driven piston are described in the Gooray '915 patent from col. 4, I. 66 to col. 6, I. 53 with respect to FIGS. 2-5.

Again referring to the present FIG. 2, in another embodiment, one or more of the micromechanical dispensing mechanisms 210, 212 comprises magnetically-actuated membranes.

In one embodiment, for example, one or more of the present micromechanical dispensing mechanisms 210, 212 comprises a membrane that is similar or identical to the magnetically-actuated diaphragm 38 of the fluid ejector 12 depicted in FIG. 7 of U.S. Pat. No. 6,234,608 B1 to Frank C. Genovese et al., which patent is incorporated by reference herein, and which patent is hereinafter referred to as the “Genovese patent” or simply “Genovese.”

Referring now to the Genovese patent, FIG. 7 discloses a micro-electromechanical fluid ejector 12. As Genovese depicts in FIG. 7 and describes at col. 5, II. 9-40, the fluid drop ejector 12 comprises a silicon plate 32, possessing two parallel surfaces 33, 34, with a thickness of about 20 mils (0.020 inches) or approximately 500 microns. The silicon plate 32 is anisotropically etched from the surface 34 to form a recess 36 and form a membrane 38 for use as a diaphragm. The diaphragm 38, with a bottom surface 37 is preferably about 1 micron in thickness.

Alternatively, as described in Genovese at col. 5, II. 16-19, a plate of silicon or ceramic could be used in conjunction with an appropriate process such as molding or laser ablation. The silicon top surface 33 has an electrode 40 deposited onto it such that at least a portion of the electrode 40 lies on top of diaphragm 38. An orifice plate 44 with internal cavity 49, and aligned with diaphragm 38 is formed on silicon surface 33. As described at col. 5, II. 35-40, the internal cavity 49 is filled with fluid.

The operation of the Genovese magnetically-actuated diaphragm is described at col. 5, II. 41-67, with reference to FIG. 7. The fluid ejector is subject to a predetermined magnetic field B with a field direction extending upward with respect to FIG. 7, the upwards direction corresponding to a direction approximately perpendicular to surface 33 and electrode 40. As the result of the selective application of electric current pulses from left to right through the electrode 40 (again with reference to FIG. 7), a Force F is generated which deforms the diaphragm 38 in the upward direction towards the nozzle. As described in Genovese at col. 5, II. 50-59, this application of pulses results in ejection of drops from the nozzle, with drop volume determined by the electric current pulses.

Still referring to the Genovese patent, the process for forming the micromechanical dispensing mechanism is described from col. 7, I. 13 to col. 8, I. 51 and depicted in FIGS. 4-8.

Referring again to the present FIG. 2, in another embodiment, one or more of the micromechanical dispensing mechanisms 210, 212 comprises a ballistic aerosol micromechanical dispensing mechanism.

In one embodiment, for example, one or more of the present micromechanical dispensing mechanisms 210, 212 are similar or identical to the aerosol ballistic dispensing device 24 as depicted in FIG. 2 as described and depicted in the foregoing U.S. Pat. No. 6,116,718 to Eric Peeters et al., which patent is incorporated by reference herein, and which patent is hereinafter referred to as the “Peeters '718 patent.”

Referring now to the Peeters '718 patent, FIG. 2, there is described from col. 6, I. 66 to col. 7, I. 28 a ballistic aerosol dispensing device 24, particularly adapted for deposition of materials onto a substrate for printing. The ballistic aerosol dispensing device comprises a body 26 within which is formed a plurality of cavities 28 for receiving materials to be dispensed, in the case of the Peeters '718 patent to be deposited on a surface. Also formed in body 26 may be a propellant cavity 30. Fitting 32 may be provided for connecting cavity 30 to a propellant source 33 such as a compressor, a propellant reservoir or the like. Body 26 may be connected to a print head 34 that will be discussed later. As depicted in FIG. 3 and described at col. 7, II. 29-40, the cavities 28 further comprise ports 42, which provide communication between cavities 28 and a channel 46. In a similar manner, as described with reference to FIG. 3 and described at col. 8, II. 41-65, cavity 30 includes a port 44 providing communication between the cavity and channel 46 through which propellant may travel.

An embodiment for the operation of a ballistic aerosol dispensing device is described in the Peeters '718 patent as described from col. 8, I. 48 to col. 9, I. 6, with reference to FIG. 3. In operation, propellant enters the channel 46 through port 44, from the propellant cavity 30. The propellant may continuously flow through the channel while the dispensing apparatus is operative, or may be modulated such that the propellant passes through the channel only when material is to be dispensed. Such propellant modification may be accomplished by a valve 31 interposed between the propellant source 33 and the channel 46. Material may controllably enter the channel 46 through one or more of the ports 42.

Still referring to the Peeters '718 patent, one embodiment of a process for forming a micromechanical dispensing mechanism incorporating a ballistic aerosol mechanism is described from col. 9, I. 7 to col. 10, I. 7, and depicted in FIGS. 40A-F.

Again referring to the present FIG. 2, in another embodiment, one or more of the micromechanical dispensing mechanisms 210, 212 comprises an arrangement incorporating a thermally-actuated paddle vane.

In one embodiment, for example, one or more of the present micromechanical dispensing mechanisms 210, 212 comprises an arrangement comprising a thermally-actuated paddle vane that is similar or identical to the fluid ejector 20 as described and depicted in the foregoing U.S. Pat. No. 6,180,427 to Kia Silverbrook, which patent is incorporated by reference herein, and which patent is hereinafter referred to as the “Silverbrook patent” or simply “Silverbrook.”

Referring now to the Silverbrook patent, FIGS. 4-5, there is described from col. 9, I. 58 to col. 10, I. 60 a nozzle arrangement comprising a thermally-actuated paddle vane for dispensing fluids, the nozzle arrangement formed using standard micro-electromechanical (MEMS) techniques. The nozzle arrangement comprises an actuator arm 21 which includes a bottom arm 22, constructed from a conductive material such as a copper nickel alloy, and a top layer 25 composed from the same material. The layer 22 includes a tapered end portion near the end post 24. The layer 22 is connected to the lower CMOS layers 26, which are formed in the standard manner on a silicon substrate surface 27. The tapering of layer 22 means that any conductive resistive heating occurs near the post portion 24. The actuator arm 21 is interconnected to an ejection paddle located within a nozzle chamber 28. The nozzle chamber includes an ejection nozzle 29 from which ink, in the case of Silverbrook, is ejected. The nozzle further includes a slot arrangement 30, which results in minimum fluid outflow through the actuator arm interconnection and also results in minimal pressure increases in this area. An ink supply channel 39 is provided by back etching through the wafer to the back surface of the nozzle.

Still referring to Silverbrook, one embodiment for the operation of a fluid micromechanical dispensing mechanism comprising an arrangement that further comprises a thermally-actuated paddle vane is described at col. 9, II. 10-57, with reference to FIGS. 2-3. Inside nozzle chamber 2, a paddle type device 7 is interconnected to an actuator arm 8 through a slot in the wall of nozzle chamber 2. The actuator arm includes a heater means, e.g., 9 located adjacent to a post end portion 20, the post end affixed to a substrate. To eject a drop, heater means 9 is heated so as to undergo thermal expansion. Ideally, the heater means is located adjacent to the post end portion 20 such that the effects of activation result in large movements of the paddle end 7. Upon heating, the heating means 9 undergoes thermal expansion, resulting in a general increase in pressure around the meniscus 5. The heater current is pulsed and fluid is ejected out of the nozzle 4 in addition to flowing in from the fluid channel 3. Subsequently, the paddle 7 is deactivated to again return to its quiescent position.

Still referring to the Sliverbrook patent, there is described one embodiment of a process for forming a fluid micromechanical dispensing mechanism that comprises a thermally-actuated paddle vane using standard MEMS techniques from col. 10, I, 64 to col. 13, I. 41, with reference to FIGS. 8-25.

Referring now to FIG. 3, there is depicted one embodiment of a system 300 for dispensing one or more fluids into the atmosphere, in accordance with the present invention. As shown, the system 300 comprises a system controller 310 arranged to communicate with the micromechanical dispensing device 200 that is described above in connection with FIG. 2.

In one embodiment of the system 300, one or more of the micromechanical dispensing mechanisms 210, 212 comprises an electrostatically-driven membrane substantially similar, or identical to the electrostatically-driven membrane described in the foregoing Kubby patent.

In another embodiment of the system 300, one or more of the micromechanical dispensing mechanisms 210, 212, comprises an electrostatically-actuated piston substantially similar, or identical to the electrostatically-actuated piston described in the foregoing Gooray '915 patent.

In a further embodiment of the system 300, one or more of the micromechanical dispensing mechanisms 210, 212, comprises a magnetically-actuated membrane substantially similar, or identical to the magnetically-actuated membrane described in the foregoing Genovese patent.

In a further embodiment of the system 300, one or more of the micromechanical dispensing mechanisms 210, 212, comprises a thermally-actuated paddle vane substantially similar, or identical to the thermally-actuated paddle-vane described in the foregoing Silverbrook patent.

In yet a further embodiment of the system 300, one or more of the micromechanical dispensing mechanisms 210, 212, comprises a ballistic aerosol dispensing mechanism substantially similar, or identical to the ballistic aerosol dispensing mechanism described in the foregoing Peeters '718 patent.

Still referring to FIG. 3, in one embodiment of the system 300, the system 300 is arranged to dispense a plurality of fluids. The micromechanical dispensing device 200 comprises two or more micromechanical dispensing devices 210, 212, one micromechanical dispensing device 210 dispensing a first fluid 271 and one or more dispensing devices 212 dispensing one or more fluids 273 different from the first fluid 271.

In another embodiment of the system 300 wherein the system 300 is arranged to dispense a plurality of fluids, the system 300 further comprises at least one additional dispenser, depicted in FIG. 3 by the reference numbers 100, 200, 400, 600, 700. The dispensers 100, 400, 600 and 700 are described below.

The dispenser 100 is depicted in FIG. 1. Referring now to FIG. 1, as depicted therein, the dispenser 100 represents any known device for dispensing fluids into the atmosphere which device is controllable by a system controller.

As to the dispensers 400, 600 and 700, embodiments of these micromechanical dispensing devices will be described with reference to FIGS. 4, 6 and 7 respectively.

Returning to FIG. 3, as depicted therein, the micromechanical dispensing device 200 dispenses a first fluid (271 with reference to FIG. 2) and the at least one additional dispenser (100, 200, 400, 600, 700) dispenses a second fluid 360 which is different from the first fluid.

By way of example only, in various embodiments, the dispensing devices depicted by reference numbers 100, 200, 400, 600, 700 may dispense a perfume, a pheromone, a fragrance, a disinfectant, a moisturizer, a humectant, a miticide, a fumigant, a deodorizer, a sanitizing agent or an insecticide.

Still referring to FIG. 3, the system controller 310 is arranged to communicate with the optional system sensor 330, which is described in more detail below, and the dispensing devices depicted by reference numbers 100, 200, 400, 600 and 700. The communication path 341 is operatively connected to the system controller 310 communication interface 313 and communication means 340. The optional system sensor 330 and dispensing devices 100, 200, 400, 600, 700 are arranged to communicate by means of communication means 340 and their corresponding communication paths or links 342, 343, 344. Embodiments for communication with devices and sensors are well-known to those skilled in the art.

In one embodiment, the communication paths 341-344 and communication means 340 comprise a network.

In another embodiment, the communication paths 341-344 and communication means 340 comprise a wireless network.

In a further embodiment, the communication paths 341-344 and communication means 340 comprise a universal serial bus.

In yet a further embodiment, the communication paths 341-344 and communication means 340 comprise a twisted wire pair.

In one embodiment, the communication means 340 comprises a network hub.

In another embodiment, the communication means 340 comprises a universal serial bus port adapter.

Still referring to FIG. 3, the system 300 may optionally comprise a system sensor 330 responsive to the concentration of an atmospheric substance 350. In one embodiment the optional system sensor 330 is responsive to the concentration of an atmospheric substance 350 corresponding to a fluid 271, 360 that has been dispensed by the system 300.

Sensors responsive to the airborne concentration of substances in the atmosphere are well-known to those skilled in the art. By way of example only, in one embodiment the optional system sensor 330 comprises a device substantially similar, or identical to the sensor described in the foregoing Lewis patent.

In one embodiment, the system controller 310 is responsive to the system sensor signal 345 provided by optional system sensor 330 responsive to the concentration of an atmospheric substance 350, and the system controller 310, in response thereto, actuates at least one dispensing device depicted by reference numbers 100, 200, 400, 600 and 700.

In another embodiment of the system 300, the micromechanical dispensing device 200 further comprises optional sensor 260 responsive to the concentration of an atmospheric substance 350. In a further embodiment the optional sensor 260 is responsive to the concentration of an atmospheric substance 350 corresponding to a fluid 271, 360 that has been dispensed by the system 300.

In one embodiment, the optional sensor 260 communicates a sensor signal 263 based on the airborne concentration of an atmospheric substance 350 by means of communication path 343 to system controller 310.

In one embodiment, the system controller 310 is responsive to the sensor signal 263 provided by optional sensor 260 indicative of the concentration of an atmospheric substance, and the system controller 310 in response thereto, actuates at least one dispensing device 100, 200, 400, 600, 700.

Sensors responsive to the airborne concentration of substances in the atmosphere are well-known to those skilled in the art. By way of example only, in one embodiment the optional sensor 260 comprises a device substantially similar, or identical to the sensor described in the foregoing Lewis patent.

Referring now to FIG. 4, there is depicted another embodiment of a micromechanical dispensing device 400 for dispensing one or more fluids into the atmosphere, in accordance with the present invention.

As shown, the micromechanical dispensing device 400 comprises a plurality of micromechanical dispensing mechanisms 410, 411, 412 fluidly connected to fluid reservoirs 420, 421, 422.

The micromechanical dispensing mechanisms 410, 411, 412 possess inlets 413, 414, 415 for receiving a fluid to be dispensed. The inlets 413, 414, 415 are fluidly connected to channels 454, 455, 456 that conduct fluid from fluid reservoirs 420, 421, 422 to micromechanical dispensing mechanisms 410, 411, 412. The fluid reservoirs 420, 421, 422 are removably fluidly coupled to ports 426, 427, 428 by means of the port coupling mechanisms 423, 424, 425 of the fluid reservoirs 420, 421, 422. One skilled in the art is familiar with a variety of means to construct a removable fluid reservoir.

By way of example only, in one embodiment the fluid reservoirs 420, 421, 422 are similar or identical to the fluid reservoir described in the foregoing Carrese patent.

In one embodiment of the micromechanical dispensing device 400, there are optional check valves 451, 452, 453 interposed between the fluid reservoirs and the corresponding fluid reservoir ports 423, 424, 425.

Still referring to FIG. 4, in one embodiment, one or more of the fluid reservoirs 420, 421, 422 contains a perfume, the corresponding micromechanical dispensing mechanisms 410, 411, 412 dispensing the perfume. In another embodiment, one or more of the fluid reservoirs 420, 421, 422 contains a disinfectant, the corresponding micromechanical dispensing mechanisms 410, 411, 412 dispensing the disinfectant. In yet another embodiment, one or more of the fluid reservoirs 420, 421, 422 contains a sanitizing agent, the corresponding micromechanical dispensing mechanisms 410, 411, 412 dispensing the sanitizing agent. In another embodiment, one or more of the fluid reservoirs 420, 421, 422 contains a pheromone, the corresponding micromechanical dispensing mechanisms 410, 411, 412 dispensing the pheromone. In a further embodiment, one or more of the fluid reservoirs 420, 421, 422 contains an insecticide, the corresponding micromechanical dispensing mechanisms 410, 411, 412 dispensing the insecticide. In a further embodiment, one or more of the fluid reservoirs 420, 421, 422 contains a miticide, the corresponding micromechanical dispensing mechanisms 410, 411, 412 dispensing the miticide; a miticide being one of the well-known materials to kill mites. In a further embodiment, one or more of the fluid reservoirs 420, 421, 422 contains a humectant, the corresponding micromechanical dispensing mechanisms 410, 411, 412 dispensing the humectant. As will be appreciated by one skilled in the art, there are numerous fluids suitable for use with the micromechanical dispensing device 400 to control the quality or other aspects of the atmosphere for aesthetic, hygienic or mood enhancing effects.

In one embodiment of the micromechanical dispensing device 400, one or more of the micromechanical dispensing mechanisms 410, 411, 412, comprises an electrostatically-driven membrane substantially similar, or identical to the electrostatically-driven membrane described in the foregoing Kubby patent.

In another embodiment of the micromechanical dispensing device 400, one or more of the micromechanical dispensing mechanisms 410, 411, 412, comprises an electrostatically-actuated piston substantially similar, or identical to the electrostatically-actuated piston described in the foregoing Gooray '915 patent.

In a further embodiment of the micromechanical dispensing device 400, one or more of the micromechanical dispensing mechanisms 410, 411, 412, comprises a magnetically-actuated membrane substantially similar, or identical to the magnetically-actuated membrane described in the foregoing Genovese patent.

In a further embodiment of the micromechanical dispensing device 400, one or more of the micromechanical dispensing mechanisms 410, 411, 412, comprises a thermally-actuated paddle vane substantially similar, or identical to the thermally-actuated paddle-vane described in the foregoing Silverbrook patent.

In yet a further embodiment one of the micromechanical dispensing device 400, or more of the micromechanical dispensing mechanisms 410, 411, 412, comprises a ballistic aerosol dispensing mechanism substantially similar, or identical to the ballistic aerosol dispensing mechanism described in the foregoing Peeters '718 patent.

Referring still to FIG. 4, the micromechanical dispensing mechanisms 410, 411, 412 are arranged for communication with the micromechanical dispensing device controller 440 by means of communication path 431. The micromechanical dispensing device controller 440 actuates micromechanical dispensing mechanisms 410, 411, 412 by means of control signals transmitted on communication path 431. The micromechanical dispensing device controller 440 may receive external signals for programmatic control by means of control interface 434 coupled to the micromechanical device controller 440 by means of communication path 433.

The micromechanical dispensing device controller 440 may comprise any of a number of well-known control and programming electronic circuits or devices well-known to those skilled in the art. By way of example only, in various embodiments the micromechanical dispensing device controller 440 may comprise an ASIC, a PGA, a PROM, an EPROM, an EEPROM, an FPGA, or a discrete circuit. In one embodiment the micromechanical dispensing device controller 440 is comprised of electronic circuitry that is a part of the same micromechanical structure comprising one or more of the micromechanical dispensing mechanisms 410, 411, 412.

In one embodiment, the micromechanical dispensing device 400 further comprises optional sensor 460 responsive to the concentration of an atmospheric substance 480. In a further embodiment the optional sensor 460 is responsive to the concentration of an atmospheric substance 480 corresponding to one or more fluids 471, 472, 473 that have been dispensed by the micromechanical dispensing device 400.

Optionally, the sensor 460 may be operatively connected to the micromechanical dispensing device controller 440 by means of communication path 432. In one embodiment, the optional sensor 460 communicates a sensor signal 435 based on the airborne concentration of an atmospheric substance 480 by means of communication path 432 to the micromechanical dispensing device controller 440. In a further embodiment the micromechanical dispensing device controller 440, responsive to the sensor signal 435, actuates one or more of the micromechanical dispensing mechanisms 410, 411, 412.

In another embodiment, the optional sensor 460 transmits a sensor signal 463 based on the airborne concentration of an atmospheric substance 480 by means of communication path 461 connected to the sensor communication interface 462.

Sensors responsive to the airborne concentration of substances in the atmosphere are well-known to those skilled in the art. By way of example only, in one embodiment the optional sensor 460 comprises a device substantially similar, or identical to the sensor described in the foregoing Lewis patent.

In one embodiment, the micromechanical dispensing device 400 comprises a dispersion pad 490 positioned to receive a fluid dispensed by one or more of the micromechanical dispensing mechanisms 410, 411, 412.

The dispersion pad 490 may comprise any natural or synthetic material or polymer, fiber or strand, either singular or woven, twisted, braided, bundled, molded or shaped in a manner that transports fluid or vapors by capillary action or that can serve as a support medium for the fluid or vapors.

By way of example only, the dispersion pad 490 may comprise porous ceramics; celluloseic fibers such as flax, cotton or wood; protein based fibers such as wool or other animal hides; or, synthetics such as nylon, polyester or other olefinic polymers or fibers.

The dispersion pad 490 is separated from the micromechanical dispensing device 400 by a gap 491-491′.

In one embodiment of the micromechanical dispensing device 400, the gap 491-491′ is minimized to achieve substantially zero distance, providing intimate contact between the dispersion pad 490 and the micromechanical dispensing device 400.

Additionally depicted in FIG. 4 is an optional orifice plate 495, further comprising an orifice 496. The optional orifice plate 495 is arranged such that fluid dispensed by at least one of the micromechanical dispensing mechanisms 410, 411, 412 is further dispensed through the orifice 496.

In one embodiment, the optional orifice plate 495 is similar or identical to the orifice plate described in the forgoing Martens patent.

Referring now to FIG. 5 there is depicted another embodiment of a system 500 to dispense one or more fluids into an atmosphere, in accordance with the present invention. As shown, the system 500 comprises a system controller 510 arranged to communicate with the micromechanical dispensing device 400 that is described above in connection with FIG. 4.

In one embodiment of the system 500, one or more of the micromechanical dispensing mechanisms 410, 411, 412, comprises an electrostatically-driven membrane substantially similar, or identical to the electrostatically-driven membrane described in the foregoing Kubby patent.

In another embodiment of the system 500, one or more of the micromechanical dispensing mechanisms 410, 411, 412, comprises an electrostatically-actuated piston substantially similar, or identical to the electrostatically-actuated piston described in the foregoing Gooray '915 patent.

In a further embodiment of the system 500, one or more of the micromechanical dispensing mechanisms 410, 411, 412, comprises a magnetically-actuated membrane substantially similar, or identical to the magnetically-actuated membrane described in the foregoing Genovese patent.

In a further embodiment of the system 500, one or more of the micromechanical dispensing mechanisms 410, 411, 412, comprises a thermally-actuated paddle vane substantially similar, or identical to the thermally-actuated paddle-vane described in the foregoing Silverbrook patent.

In yet a further embodiment of the system 500, one or more of the micromechanical dispensing mechanisms 410, 411, 412, comprises a ballistic aerosol dispensing mechanism substantially similar, or identical to the ballistic aerosol dispensing mechanism described in the foregoing Peeters '718 patent.

In one embodiment of the system 500, the system 500 is arranged to dispense a plurality of fluids, the micromechanical dispensing device 400 dispensing a first fluid 471 and a second fluid 472 different from the first fluid 471.

Referring still to FIG. 5, in another embodiment of the system 500 wherein the system 500 is arranged to dispense a plurality of fluids, the system 500 further comprises at least one additional dispenser depicted by the reference numbers 100, 200, 400, 600 and 700. The dispensers 100, 200 and 400 are described above in connection with FIGS. 1, 2 and 4, respectively. Embodiments of micromechanical dispensing devices 600, 700 are described below in connection with FIGS. 6 and 7 respectively. In this embodiment the micromechanical dispensing device 400 dispenses a first fluid (471 with reference to FIG. 4) and the at least one additional dispenser (100, 200, 400, 600, 700) dispenses a second fluid 560 which is different from the first fluid 471.

By way of example only, in various embodiments, the system 500 may dispense a perfume, a pheromone, a fragrance, a disinfectant, a moisturizer, a humectant, a miticide, a fumigant, a deodorizer, a sanitizing agent or an insecticide.

The system controller 510 is arranged to communicate with the optional system sensor 530, which is described in more detail below, and the dispensing devices depicted by reference numbers 100, 200, 400, 600 and 700. The communication path 541 is operatively connected to the system controller 510 communication interface 513 and communication means 540. The optional system sensor 530 and the micromechanical dispensing devices depicted by reference numbers 100, 200, 400, 600 and 700 are arranged to communicate by means of communication means 540 and their corresponding communication paths 542, 543, 544. Embodiments for communication with devices and sensors are well known to those skilled in the art.

In one embodiment, the communication paths 541-544 and the communication means 540 comprise a network.

In another embodiment, the communication paths 541-544 and the communication means 540 comprise a wireless network.

In a further embodiment, the communication paths 541-544 and the communication means 540 comprise a universal serial bus.

In yet a further embodiment, the communication paths 541-544 and the communication means 540 comprise a twisted wire pair.

In one embodiment, the communication means 540 comprises a network hub.

In another embodiment, the communication means 540 comprises a universal serial bus port adapter.

Still referring to FIG. 5, the system 500 may optionally comprise a system sensor 530 responsive to the concentration of an atmospheric substance 550. In one embodiment the optional system sensor 530 is responsive to the concentration of an atmospheric substance 550 corresponding to a fluid 471, 472, 560 that has been dispensed by the system 500.

Sensors responsive to the airborne concentration of substances in the atmosphere are well-known to those skilled in the art. By way of example only, in one embodiment the optional system sensor 530 comprises a device similar or identical to the sensor described in the foregoing Lewis patent.

In one embodiment, the system controller 510 is responsive to the system sensor signal 545 provided by optional system sensor 530 responsive to the concentration of an atmospheric substance 550, and the system controller 510 in response thereto, actuates at least one dispensing device depicted by reference numbers 100, 200, 400, 600 and 700.

In another embodiment of the system 500, the micromechanical dispensing device 400 further comprises optional sensor 460 responsive to the concentration of an atmospheric substance 550. In a further embodiment the optional sensor 460 is responsive to the concentration of an atmospheric substance 550 corresponding to a fluid 471, 472, 560 that has been dispensed by the system 500.

In one embodiment, the optional sensor 460 communicates a sensor signal 463 based on the airborne concentration of an atmospheric substance 550 by means of communication path 543 to system controller 510.

In one embodiment, the system controller 510 is responsive to the sensor signal 463 provided by optional sensor 460 indicative of the concentration of an atmospheric substance, and the system controller 510 in response thereto, actuates at least one dispensing device depicted by reference numbers 100, 200, 400, 600 and 700.

Sensors responsive to the airborne concentration of substances in the atmosphere are well-known to those skilled in the art. By way of example only, in one embodiment the optional sensor 460 comprises a device substantially similar, or identical to the sensor described in the foregoing Lewis patent.

Referring now to FIG. 6, there is depicted a further embodiment of a micromechanical dispensing device 600 for dispensing one or more fluids into the atmosphere, in accordance with the present invention.

The micromechanical dispensing device 600 comprises a micromechanical dispensing mechanism 610 fluidly connected to a plurality of fluid reservoirs 620, 621, 622.

The micromechanical dispensing mechanism 610 possess an inlet 613 for receiving fluids to be dispensed by means of channel 611-611′. The channel 611-611′ is fluidly connected to the exit of valve 665. The valve 665 selectively couples fluid reservoirs 620, 621, 622 to dispensing mechanism 610 as described in more detail below. The channel 612 conducts fluid from fluid reservoirs 620, 621, 622 to the entrance of valve 665. The channel 612 is fluidly connected to ports 626, 627, 628. The ports 626, 627, 628 provide removable fluid coupling to the fluid reservoirs 620, 621, 622 by means of ports 623, 624, 625 of the fluid reservoirs 620, 621, 622.

One skilled in the art is familiar with a variety of means to construct a removable fluid reservoir. By way of example only, in one embodiment the fluid reservoirs 620, 621, 622 are similar or identical to the fluid reservoir described in the foregoing Carrese patent.

The valve 665 is arranged to communicate with the micromechanical dispensing device controller 640, described in more detail below, by means of communication path 637. The micromechanical dispensing device controller 640 controls the operation of the valve 665 to selectively couple the micromechanical dispensing mechanism 610 to the fluid reservoirs 620, 621, 622.

Valves for micromechanical systems are well-known to those skilled in the art. By way of example only, in one embodiment, the valve 665 comprises a device substantially similar or identical to the valve described in U.S. Pat. No. 6,561,224 to Steven T. Cho, which patent is incorporated by reference herein.

In one embodiment of the micromechanical dispensing device 600, there are one or more optional check valves 651, 652, 653 interposed between the fluid reservoirs 620, 621, 622 and their corresponding fluid reservoir ports 623, 624, 625.

Still referring to FIG. 6, in one embodiment, the micromechanical dispensing device 600 further comprises a mixing chamber 670 situated between channel elements 611 and 611′ to combine fluids.

Referring still to FIG. 6, in one embodiment, one or more of the fluid reservoirs 620, 621, 622 contains a perfume, the micromechanical dispensing mechanism 610 dispensing the perfume. In another embodiment, one or more of the fluid reservoirs 620, 621, 622 contains a disinfectant, the micromechanical dispensing mechanism 610 dispensing the disinfectant. In yet another embodiment, one or more of the fluid reservoirs 620, 621, 622 contains a sanitizing agent, the micromechanical dispensing mechanism 610 dispensing the sanitizing agent. In another embodiment, one or more of the fluid reservoirs 620, 621, 622 contains a pheromone, the micromechanical dispensing mechanism 610 dispensing the pheromone. In a further embodiment, one or more of the fluid reservoirs 620, 621, 622 contains an insecticide, the micromechanical dispensing mechanism 610 dispensing the insecticide. In a further embodiment, one or more of the fluid reservoirs 620, 621, 622 contains a miticide, the micromechanical dispensing mechanism 610 dispensing the miticide; a miticide being one of the well-known materials to kill mites. In a further embodiment, one or more of the fluid reservoirs 620, 621, 622 contains a humectant, the micromechanical dispensing mechanism 610 dispensing the humectant. As will be appreciated by one skilled in the art, there are numerous fluids suitable for use with the micromechanical dispensing device 600 to control the quality or other aspects of the atmosphere for aesthetic, hygienic or mood enhancing effects.

In one embodiment of the micromechanical dispensing device 600, the micromechanical dispensing mechanism 610 comprises an electrostatically-driven membrane substantially similar, or identical to the electrostatically-driven membrane described in the foregoing Kubby patent.

In another embodiment of the micromechanical dispensing device 600 the micromechanical dispensing mechanism 610 comprises an electrostatically-actuated piston substantially similar, or identical to the electrostatically-actuated piston described in the foregoing Gooray '915 patent.

In a further embodiment of the micromechanical dispensing device 600 the micromechanical dispensing mechanism 610 comprises a magnetically-actuated membrane substantially similar, or identical to the magnetically-actuated membrane described in the foregoing Genovese patent.

In a further embodiment of the micromechanical dispensing device 600 the micromechanical dispensing mechanism 610 comprises a thermally-actuated paddle vane substantially similar, or identical to the thermally-actuated paddle-vane described in the foregoing Silverbrook patent.

In yet a further embodiment of the micromechanical dispensing device 600 the micromechanical dispensing mechanism 610 comprises a ballistic aerosol dispensing mechanism substantially similar, or identical to the ballistic aerosol dispensing mechanism described in the foregoing Peeters '718 patent.

Referring still to FIG. 6, the micromechanical dispensing mechanism 610 is arranged for communication with the micromechanical dispensing device controller 640 by means of communication path 631. The micromechanical dispensing device controller 640 actuates the micromechanical dispensing mechanism 610 by means of control signals transmitted on communication path 631. The micromechanical dispensing device controller 640 may receive external signals for programmatic control by means of control interface 634 coupled to the micromechanical device controller 640 by means of communication path 633.

The micromechanical dispensing device controller 640 may comprise any of a number of well-known control and programming electronic circuits or devices well-known to those skilled in the art. By way of example only, in various embodiments the micromechanical dispensing device controller 640 may comprise an ASIC, a PGA, a PROM, an EPROM, an EEPROM, an FPGA, or a discrete circuit. In one embodiment the micromechanical dispensing device controller 640 is comprised of electronic circuitry that is a part of the same micromechanical structure comprising the micromechanical dispensing mechanism 610.

In one embodiment, the micromechanical dispensing device 600 further comprises optional sensor 660 responsive to the concentration of an atmospheric substance 680. In a further embodiment the optional sensor 660 is responsive to the concentration of an atmospheric substance 680 corresponding to one or more fluids 671, 672, 673 that have been dispensed by the micromechanical dispensing device 600.

Optionally, the sensor 660 may be operatively connected to the micromechanical dispensing device controller 640 by means of communication path 632. In one embodiment, the optional sensor 660 communicates a sensor signal 635 based on the airborne concentration of an atmospheric substance 680 by means of communication path 632 to the dispensing device controller 640. In a further embodiment, the micromechanical dispensing device controller 610, responsive to sensor signal 635, actuates the micromechanical dispensing mechanism 610.

In another embodiment, the optional sensor 660 transmits a sensor signal 663 based on the airborne concentration of an atmospheric substance 680 by means of communication path 661 connected to the sensor communication interface 662.

Sensors responsive to the airborne concentration of substances in the atmosphere are well-known to those skilled in the art. By way of example only, in one embodiment the optional sensor 660 comprises a device substantially similar, or identical to the sensor described in the foregoing Lewis patent.

In one embodiment, the micromechanical dispensing device 600 comprises a dispersion pad 690 positioned to receive a fluid dispensed by the micromechanical dispensing mechanism 610.

The dispersion pad 690 may comprise any natural or synthetic material or polymer, fiber or strand, either singular or woven, twisted, braided, bundled, molded or shaped in a manner that transports fluid or vapors by capillary action or that can serve as a support medium for the fluid or vapors.

By way of example only, the dispersion pad 690 may comprise porous ceramics; celluloseic fibers such as flax, cotton or wood; protein based fibers such as wool or other animal hides; or, synthetics such as nylon, polyester or other olefinic polymers or fibers.

The dispersion pad 690 is separated from the micromechanical dispensing device 600 by a gap 691-691′.

In one embodiment of the micromechanical dispensing device 600, the gap 691-691′ is minimized to achieve substantially zero distance, providing intimate contact between the dispersion pad 690 and the micromechanical dispensing device 600.

Additionally depicted in FIG. 6 is an optional orifice plate 695, further comprising an orifice 696. The optional orifice plate 695 is arranged such that fluid dispensed by the micromechanical dispensing mechanism 610 is further dispensed through the orifice 696.

In one embodiment, the optional orifice plate 695 is similar or identical to the orifice plate described in the forgoing Martens patent.

Referring now to FIG. 7, there is depicted still another embodiment of a micromechanical dispensing device 700 for dispensing a fluid into the atmosphere, in accordance with the present invention.

As shown, the micromechanical dispensing device 700 comprises a plurality of micromechanical dispensing mechanisms 710, 711, 712 fluidly connected to a fluid reservoir 720.

The micromechanical dispensing mechanisms 710, 711, 712 possess inlets 713, 714, 715 for receiving fluids to be dispensed. The inlets 713, 714, 715 are fluidly connected to the channel 754 that conducts fluid from the fluid reservoir 720 to the micromechanical dispensing mechanisms 710, 711, 712. The fluid reservoir 720 is removably fluidly coupled to port 726 by means of the port 723 of the fluid reservoir 720.

One skilled in the art is familiar with a variety of means to construct a removable fluid reservoir. By way of example only, in one embodiment the fluid reservoir 720 is similar or identical to the fluid reservoir described in the foregoing Carrese patent.

In one embodiment of the micromechanical dispensing device 700, there is an optional check valve 751 interposed between the fluid reservoir 720 and the fluid reservoir port 723.

Referring still to FIG. 7, in one embodiment, the fluid reservoir 720 contains a perfume, one or more of the micromechanical dispensing mechanisms 710, 711, 712 dispensing the perfume.

In another embodiment, the fluid reservoir 720 contains a disinfectant, one or more of the micromechanical dispensing mechanisms 710, 711, 712 dispensing the disinfectant.

In yet another embodiment, the reservoir 720 contains a sanitizing agent, one or more of the micromechanical dispensing mechanisms 710, 711, 712 dispensing the sanitizing agent.

In another embodiment, the fluid reservoir 720 contains a pheromone, one or more of the micromechanical dispensing mechanisms 710, 711, 712 dispensing the pheromone.

In a further embodiment, the fluid reservoir 720 contains an insecticide, one or more of the micromechanical dispensing mechanisms 710, 711, 712 dispensing the insecticide.

In a further embodiment, the fluid reservoir 720 contains a miticide, one or more of the micromechanical dispensing mechanisms 710, 711, 712 dispensing the miticide; a miticide being one of the well-known materials to kill mites.

In a further embodiment, the fluid reservoir 720 contains a humectant, one or more of the micromechanical dispensing mechanisms 710, 711, 712 dispensing the humectant.

As will be appreciated by one skilled in the art, there are numerous fluids suitable for use with the micromechanical dispensing device 700 to control the quality or other aspects of the atmosphere for aesthetic, hygienic or mood enhancing effects.

In one embodiment of the micromechanical dispensing device 700, one or more of the micromechanical dispensing mechanisms 710, 711, 712 comprises an electrostatically-driven membrane substantially similar, or identical to the electrostatically-driven membrane described in the foregoing Kubby patent.

In another embodiment of the micromechanical dispensing device 700, one or more of the micromechanical dispensing mechanisms 710, 711, 712 comprises an electrostatically-actuated piston substantially similar, or identical to the electrostatically-actuated piston described in the foregoing Gooray '915 patent.

In a further embodiment of the micromechanical dispensing device 700, one or more of the micromechanical dispensing mechanism 710, 711, 712 comprises a magnetically-actuated membrane substantially similar, or identical to the magnetically-actuated membrane described in the foregoing Genovese patent.

In a further embodiment of the micromechanical dispensing device 700, one or more of the micromechanical dispensing mechanisms 710, 711, 712 comprises a thermally-actuated paddle vane substantially similar, or identical to the thermally-actuated paddle-vane described in the foregoing Silverbrook patent.

In yet a further embodiment of the micromechanical dispensing device 700, one or more of the micromechanical dispensing mechanisms 710, 711, 712 comprises a ballistic aerosol dispensing mechanism substantially similar, or identical to the ballistic aerosol dispensing mechanism described in the foregoing Peeters '718 patent.

Referring still to FIG. 7, the micromechanical dispensing mechanisms 710, 711, 712 are arranged for communication with the micromechanical dispensing device controller 740 by means of communication path 731. The micromechanical dispensing device controller 740 actuates micromechanical dispensing mechanisms 710, 711, 712 by means of control signals transmitted on communication path 731. The micromechanical dispensing device controller 740 may receive external signals for programmatic control by means of control interface 734 coupled to the micromechanical device controller 740 by means of communication path 733.

The micromechanical dispensing device controller 740 may comprise any of a number of well-known control and programming electronic circuits or devices well-known to those skilled in the art. By way of example only, in various embodiments the micromechanical dispensing device controller 740 may comprise an ASIC, a PGA, a PROM, an EPROM, an EEPROM, an FPGA, or a discrete circuit. In one embodiment the micromechanical dispensing device controller 740 is comprised of electronic circuitry that is a part of the same micromechanical structure comprising one or more of the micromechanical dispensing mechanisms 710, 711, 712.

In one embodiment, the micromechanical dispensing device 700 further comprises optional sensor 760 responsive to the concentration of an atmospheric substance 780. In a further embodiment the optional sensor 760 is responsive to the concentration of an atmospheric substance 780 corresponding to a fluid 771 that has been dispensed by the micromechanical dispensing device 700.

Optionally, the sensor 760 may be operatively connected to the micromechanical dispensing device controller 740 by means of communication path 732. In one embodiment, the optional sensor 760 communicates a sensor signal 735 based on the airborne concentration of an atmospheric substance 780 by means of communication path 732 to the dispensing device controller 740. In a further embodiment, the micromechanical dispensing device controller 710, responsive to the sensor signal 735, actuates one or more of the micromechanical dispensing mechanisms 710, 711, 712.

In another embodiment, the optional sensor 760 transmits a sensor signal 763 based on the airborne concentration of an atmospheric substance 780 by means of communication path 761 connected to the sensor communication interface 762.

Sensors responsive to the airborne concentration of substances in the atmosphere are well-known to those skilled in the art. By way of example only, in one embodiment the optional sensor 760 comprises a device substantially similar, or identical to the sensor described in the foregoing Lewis patent.

In one embodiment, the micromechanical dispensing device 700 comprises a dispersion pad 790 positioned to receive a fluid dispensed by one or more of the micromechanical dispensing mechanisms 710, 711, 712.

The dispersion pad 790 may comprise any natural or synthetic material or polymer, fiber or strand, either singular or woven, twisted, braided, bundled, molded or shaped in a manner that transports fluid or vapors by capillary action or that can serve as a support medium for the fluid or vapors.

By way of example only, the dispersion pad 790 may comprise porous ceramics, celluloseic fibers such as flax, cotton, wood, protein based fibers such as wool or other animal hides, or, synthetics such as nylon, polyester or other olefinic polymers or fibers.

The dispersion pad 790 is separated from the micromechanical dispensing device 700 by a gap 791-791′.

In one embodiment of the micromechanical dispensing device 700, the gap 791-791′ is minimized to achieve substantially zero distance, providing intimate contact between the dispersion pad 790 and the micromechanical dispensing device 700.

Additionally depicted in FIG. 7 is an optional orifice plate 795, further comprising an orifice 796. The optional orifice plate 795 is arranged such that fluid dispensed by one or more of the micromechanical dispensing mechanisms 710, 711, 712 is further dispensed through the orifice 796.

In one embodiment, the optional orifice plate 795 is similar or identical to the orifice plate described in the forgoing Martens patent.

The table below lists the drawing element reference numbers together with their corresponding written description:

TABLE

| Number: | Description: |
|---|---|
| 100 | dispenser |
| 200 | a micromechanical device to |
| | dispense one or more fluids |
| | into an atmosphere |
| 210 | micromechanical dispensing mechanism |
| 212 | micromechanical dispensing mechanisms |
| 213 | inlet |
| 214 | inlets |
| 220 | fluid reservoir |
| 222 | fluid reservoirs |
| 223 | port |
| 225 | ports |
| 226 | port |
| 228 | ports |
| 231 | communication path |
| 232 | communication path |
| 233 | communication path |
| 234 | control interface |
| 235 | sensor signal |
| 240 | micromechanical dispensing device controller |
| 251 | check valve |
| 253 | check valves |
| 254 | channel |
| 255 | channels |
| 260 | sensor |
| 261 | communication path |
| 262 | sensor communication interface |
| 263 | sensor signal |
| 271 | fluid |
| 273 | fluids |
| 280 | atmospheric substance |
| 290 | disperion pad |
| 291 | gap |
| 291′ | gap |
| 295 | orifice plate |
| 296 | orifice |
| 300 | system for dispensing fluids |
| 310 | system controller |
| 313 | communication interface |
| 330 | system sensor |
| 340 | communication means |
| 341 | communication path |
| 342 | communication path |
| 343 | communication path |
| 344 | communication path |
| 345 | system sensor signal |
| 350 | atmospheric substance |
| 360 | fluid |
| 400 | a micromechanical device |
| | to dispense a plurality of fluids |
| | into an atmosphere |
| 410 | micromechanical dispensing device |
| 411 | micromechanical dispensing device |
| 412 | micromechanical dispensing devices |
| 413 | inlet |
| 414 | inlet |
| 415 | inlets |
| 420 | fluid reservoir |
| 421 | fluid reservoir |
| 422 | fluid reservoirs |
| 423 | port |
| 424 | port |
| 425 | ports |
| 426 | port |
| 427 | port |
| 428 | ports |
| 431 | communication path |
| 432 | communication path |
| 433 | communication path |
| 434 | control interface |
| 435 | sensor signal |
| 440 | micromechanical dispensing device controller |
| 451 | check valve |
| 452 | check valve |
| 453 | check valves |
| 454 | channel |
| 455 | channel |
| 456 | channels |
| 460 | sensor |
| 461 | communication path |
| 462 | sensor communication interface |
| 463 | sensor signal |
| 471 | fluid |
| 472 | fluid |
| 473 | fluids |
| 480 | atmospheric substance |
| 490 | dispersion pad |
| 491 | gap |
| 491′ | gap |
| 495 | orifice plate |
| 496 | orifice |
| 500 | system for dispensing fluids |
| 510 | system controller |
| 513 | communication interface |
| 530 | system sensor |
| 540 | communication means |
| 541 | communication path |
| 542 | communication path |
| 543 | communication path |
| 544 | communication path |
| 545 | system sensor signal |
| 550 | atmospheric substance |
| 560 | fluid |
| 600 | a micromechanical device |
| | to dispense one or more fluids |
| | into an atmosphere |
| 610 | micromechanical dispensing mechanism |
| 611 | channel |
| 611′ | channel |
| 612 | channel |
| 613 | inlet |
| 620 | fluid reservoir |
| 621 | fluid reservoirs |
| 622 | fluid reservoir |
| 623 | port |
| 624 | ports |
| 625 | port |
| 626 | port |
| 627 | ports |
| 628 | port |
| 631 | communication path |
| 632 | communication path |
| 633 | communication path |
| 634 | dispenser control interface |
| 635 | sensor signal |
| 637 | communication path |
| 640 | micromechanical dispensing device controller |
| 651 | check valve |
| 652 | check valves |
| 653 | check valve |
| 660 | sensor |
| 661 | communication path |
| 662 | sensor communication interface |
| 663 | sensor signal |
| 665 | valve |
| 670 | mixing chamber |
| 671 | fluid |
| 672 | fluids |
| 673 | fluid |
| 680 | atmospheric substance |
| 690 | dispersion pad |
| 691 | gap |
| 691′ | gap |
| 695 | orifice plate |
| 696 | orifice |
| 700 | a micromechanical device |
| | to dispense a fluid into an |
| | atmosphere |
| 710 | micromechanical dispensing mechanism |
| 711 | micromechanical dispensing mechanism |
| 712 | micromechanical dispensing mechanisms |
| 713 | inlet |
| 714 | inlet |
| 715 | inlets |
| 720 | fluid reservoir |
| 723 | port |
| 726 | port |
| 731 | communication path |
| 732 | communication path |
| 733 | communication path |
| 734 | dispenser control interface |
| 735 | sensor signal |
| 740 | micromechanical dispensing device controller |
| 751 | check valve |
| 754 | channel |
| 760 | sensor |
| 761 | communication path |
| 762 | sensor communication interface |
| 763 | sensor signal |
| 771 | fluid |
| 780 | atmospheric substance |
| 790 | dispersion pad |
| 791 | gap |
| 791′ | gap |
| 795 | orifice plate |
| 796 | orifice |

Thus, there has been described the first aspect of the invention, namely, a micromechanical dispensing device to dispense one or more fluids into an atmosphere (200), the micromechanical dispensing device (200) comprising one or more micromechanical dispensing mechanisms (210, 212), each micromechanical dispensing mechanism of the one or more micromechanical dispensing mechanisms (210, 212) fluidly connected to a corresponding fluid reservoir (220, 222); the micromechanical dispensing device (200) further comprising a micromechanical dispensing device controller (240), the micromechanical dispensing device controller (240) arranged to communicate with each micromechanical dispensing mechanism of the one or more micromechanical dispensing mechanisms (210, 212).

In one embodiment, the micromechanical dispensing device to dispense one or more fluids into an atmosphere (200) further comprises at least one port (226, 228) to which the corresponding fluid reservoir (220, 222) may be removably, fluidly connected.

In another embodiment, in the micromechanical dispensing device to dispense one or more fluids into an atmosphere (200), at least one micromechanical dispensing mechanism of the one or more micromechanical dispensing mechanisms (210, 212) further comprises an electrostatically-driven membrane, an electrostatically-actuated piston, a magnetically-actuated membrane, a thermally-actuated paddle vane or a ballistic aerosol dispensing mechanism.

In one embodiment, in the micromechanical dispensing device to dispense one or more fluids into an atmosphere (200), at least one fluid reservoir (220, 222) contains a fluid (271), the fluid comprising a perfume, pheromone, moisturizer, humectant, miticide, deodorizer, disinfectant, sanitizing agent or insecticide.

In another embodiment, the micromechanical dispensing device to dispense one or more fluids into an atmosphere (200) further comprises a sensor (260), the sensor (260) arranged to form a sensor signal (235) responsive to an atmospheric substance (280), and to communicate the sensor signal (235) to the micromechanical dispensing device controller (240).

In a further embodiment, in the micromechanical dispensing device to dispense one or more fluids into an atmosphere 200, the atmospheric substance (280) is a fluid (271) that has been dispensed by the micromechanical dispensing device to dispense one or more fluids into an atmosphere (200).

In one embodiment, in the micromechanical dispensing device to dispense one or more fluids into an atmosphere (200), the micromechanical dispensing device controller (240) is arranged to actuate at least one of the one or more micromechanical dispensing mechanisms (210, 212) in response to the sensor signal (235).

In another embodiment, the micromechanical dispensing device to dispense one or more fluids into an atmosphere (200) further comprises one or more check valves (251, 253), wherein each of the one or more check valves (251, 253) is interposed between a corresponding micromechanical dispensing mechanism (210, 212) from amongst the one or more micromechanical dispensing mechanisms (210, 212) and the corresponding fluid reservoir (220, 222) of the corresponding micromechanical dispensing mechanism (210, 212).

In one embodiment, the micromechanical dispensing device to dispense one or more fluids into an atmosphere (200) further comprises a dispersion pad (290), wherein the dispersion pad (290) is arranged to receive at least one fluid (271) dispensed into the atmosphere by at least one of the one or more micromechanical dispensing mechanisms (210, 212), wherein the dispersion pad (290) comprises porous ceramics, celluloseic fibers, flax, cotton, wood, protein-based fibers, wool, animal hides, nylon, polyester or olefinic fibers.

In another embodiment, the micromechanical dispensing device to dispense one or more fluids into an atmosphere (200) further comprises an orifice plate (295), the orifice plate (295) comprising an orifice (296), the orifice plate (295) arranged such that at least one fluid of the one or more fluids (271) dispensed by at least one of the one or more micromechanical dispensing mechanisms (210, 212) is further dispensed through the orifice (296).

Thus, there has been described the second aspect of the invention, namely, a system to dispense a plurality of fluids into an atmosphere (300), the system (300) comprising a micromechanical dispensing device (200), the micromechanical dispensing device (200) comprising one or more micromechanical dispensing mechanisms (210, 212), each micromechanical dispensing mechanism of the one or more micromechanical dispensing mechanisms (210, 212) fluidly connected to a corresponding fluid reservoir (220, 222); the micromechanical dispensing device (200) further comprising a micromechanical dispensing device controller (240), the micromechanical dispensing device controller (240) arranged to communicate with each micromechanical dispensing mechanism of the one or more micromechanical dispensing mechanisms (210, 212); the system further comprising at least one other dispensing device (100, 200, 400, 600, 700), and a system controller (310), the system controller (310) arranged to communicate with the micromechanical dispensing device (200) and with each of the at least one other dispensing devices (100, 200, 400, 600, 700).

In one embodiment, in the system to dispense a plurality of fluids into an atmosphere (300), at least one of the one or more micromechanical dispensing mechanisms (210, 212) of the micromechanical dispensing device (200), further comprises an electrostatically-driven membrane, an electrostatically-actuated piston, a magnetically-actuated membrane, a thermally-actuated paddle vane or a ballistic aerosol dispensing mechanism.

In another embodiment, in the system to dispense a plurality of fluids into an atmosphere (300), at least one fluid reservoir (220, 221) contains a fluid (271, 273), the fluid comprising a perfume, a pheromone, moisturizer, humectant, miticide, deodorizer, disinfectant, sanitizing agent or insecticide.

In one embodiment, the system to dispense a plurality of fluids into an atmosphere (300) is arranged to dispense at least one of the plurality of fluids (271) by the micromechanical dispensing device (200) and to dispense at least one other of the plurality of fluids (360) by the at least one other dispensing device (100, 200, 400, 600, 700).

In another embodiment, the system to dispense a plurality of fluids into an atmosphere (300) further comprises a system sensor (330), the system sensor (330) arranged to form a system sensor signal (345) responsive to an atmospheric substance (350) and to communicate the system sensor signal (345) to the system controller (310).

In a further embodiment, in the system to dispense a plurality of fluids into an atmosphere (300), the system controller is arranged to actuate at least one of the micromechanical dispensing device (200) and the at least one other dispensing device (100, 200, 400, 600, 700, 800) in response to the system sensor signal (345).

In one embodiment, in the system to dispense a plurality of fluids into an atmosphere (300), the micromechanical dispensing device (200) further comprises a sensor (260), the sensor (260) arranged to form a sensor signal (263) responsive to the atmospheric substance (350) and to communicate the sensor signal (263) to the system controller (310).

In a further embodiment, in the system to dispense a plurality of fluids into an atmosphere (300), the system controller (310) is arranged to actuate at least one of the micromechanical dispensing device (200) and the at least one other dispensing device (100, 200, 400, 600, 700, 800) in response to the sensor signal (263).

In one embodiment, the system to dispense a plurality of fluids into an atmosphere (300), further comprises a communication means (340), the communication means comprising a network (340).

In another embodiment, in the system to dispense a plurality of fluids into an atmosphere (300), the network (340) comprises a wireless network (340).

Thus, there has been described the third aspect of the invention, namely, a micromechanical dispensing device to dispense a plurality of fluids into an atmosphere (400), the micromechanical dispensing device (400) comprising a plurality of micromechanical dispensing mechanisms (410, 411, 412), each micromechanical dispensing mechanism of the plurality of micromechanical dispensing mechanisms (410, 411, 412) fluidly connected to a corresponding fluid reservoir (420, 421, 422); the micromechanical dispensing device (400) further comprising a micromechanical dispensing device controller (440), the micromechanical dispensing device controller (440) arranged to communicate with each micromechanical dispensing mechanism of the plurality of micromechanical dispensing mechanisms (410, 411, 412).

In one embodiment, the micromechanical dispensing device to dispense a plurality of fluids into an atmosphere (400) further comprises at least one port (426, 427, 428) to which the corresponding fluid reservoir (420, 421, 422) may be removably, fluidly connected.

In one embodiment, in the micromechanical dispensing device to dispense a plurality of fluids into an atmosphere (400), at least one micromechanical dispensing mechanism of the plurality of micromechanical dispensing mechanisms (410, 411, 412) further comprises an electrostatically-driven membrane, an electrostatically-actuated piston, a magnetically-actuated membrane, a thermally-actuated paddle vane or a ballistic aerosol dispensing mechanism.

In another embodiment, the micromechanical dispensing device to dispense a plurality of fluids into an atmosphere (400) further comprises a fluid (471, 472), the fluid comprising a perfume, pheromone, moisturizer, humectant, miticide, deodorizer, disinfectant, sanitizing agent or insecticide.

In one embodiment, the micromechanical dispensing device to dispense a plurality of fluids into an atmosphere (400), further comprises a sensor (460), the sensor (460) arranged to form a sensor signal (435) responsive to an atmospheric substance (480) and to communicate the sensor signal (435) to the micromechanical dispensing device controller (440).

In one embodiment, in the micromechanical dispensing device to dispense a plurality of fluids into an atmosphere (400), the atmospheric substance to which the sensor signal (435) is responsive is a fluid (471, 472) that has been dispensed by the micromechanical dispensing device to dispense a plurality of fluids into an atmosphere (400).

In one embodiment, in the micromechanical dispensing device to dispense a plurality of fluids into an atmosphere (400), the micromechanical dispensing device controller (440) is arranged to actuate at least one of the plurality of micromechanical dispensing mechanisms (410, 411, 412) in response to the sensor signal (435).

In another embodiment, the micromechanical dispensing device to dispense a plurality of fluids into an atmosphere (400), further comprises at least one check valve (451, 452, 453) interposed between at least one of the plurality of micromechanical dispensing mechanisms (410,411, 412) and its corresponding fluid reservoir (420, 421, 422).

In one embodiment, the micromechanical dispensing device to dispense a plurality of fluids into an atmosphere (400), further comprises a dispersion pad (490), wherein the dispersion pad (490) is arranged to receive at least one fluid (471, 472) dispensed into the atmosphere by at least one of the plurality of micromechanical dispensing mechanisms (410, 411, 412), wherein the dispersion pad (490) comprises porous ceramics, celluloseic fibers, flax, cotton, wood, protein-based fibers, wool, animal hides, nylon, polyester or olefinic fibers.

In one embodiment, the micromechanical dispensing device to dispense a plurality of fluids into an atmosphere (400), further comprises an orifice plate (495), the orifice plate (495) comprising an orifice (496), the orifice plate (495) arranged such that at least one fluid of the plurality of fluids (471, 472) dispensed by at least one of the plurality of micromechanical dispensing mechanisms (410, 411, 412) is further dispensed through the orifice (496).

Thus, there has been described the fourth aspect of the invention, namely, a system to dispense a plurality of fluids into an atmosphere (500), the system (500) comprising a micromechanical dispensing device (400), the micromechanical dispensing device (400) comprising a plurality of micromechanical dispensing mechanisms (410, 411, 412), each micromechanical dispensing mechanism of the plurality of micromechanical dispensing mechanisms (410, 411, 412) fluidly connected to a corresponding fluid reservoir (420, 421, 422); the micromechanical dispensing device (400) further comprising a micromechanical dispensing device controller (440), the micromechanical dispensing device controller (440) arranged to communicate with each micromechanical dispensing mechanism of the plurality of micromechanical dispensing mechanisms (410, 411, 412); and the system further comprising a system controller (510), the system controller (510) arranged to communicate with the micromechanical dispensing device (400).

In one embodiment, in the system to dispense a plurality of fluids into an atmosphere (500), at least one of the plurality of micromechanical dispensing mechanisms (410, 411, 412) of the micromechanical dispensing device (400), further comprises an electrostatically-driven membrane, an electrostatically-actuated piston, a magnetically-actuated membrane, a thermally-actuated paddle vane or a ballistic aerosol dispensing mechanism.

In one embodiment, in the system to dispense a plurality of fluids into an atmosphere (500), at least one fluid reservoir (420, 421) of the micromechanical dispensing device (400) contains a fluid (471, 472), the fluid comprising a perfume, pheromone, moisturizer, humectant, miticide, deodorizer, disinfectant, sanitizing agent or insecticide.

In one embodiment, the system to dispense a plurality of fluids into an atmosphere (500), further comprises a second dispenser to dispense one or more fluids into an atmosphere (100, 200, 400, 600, 700), the second dispenser (100, 200, 400, 600, 700), arranged to communicate with the system controller 510, wherein at least one fluid reservoir (420, 421) of the micromechanical dispensing device (400) contains a first fluid (471, 472) and the second dispenser (100, 200, 400, 600, 700) contains a second fluid (560) which is different from the first fluid (471, 472).

In one embodiment, the system to dispense a plurality of fluids into an atmosphere (500) further comprises a system sensor (530), the system sensor (530) arranged to form a system sensor signal (545) responsive to an atmospheric substance (550) and to communicate the system sensor signal (545) to the system controller (510).

In a further embodiment, in the system to dispense a plurality of fluids into an atmosphere (500), the system controller (510) is arranged to actuate the micromechanical dispensing device (400) in response to the system sensor signal (545).

In one embodiment, in the system to dispense a plurality of fluids into an atmosphere (500), the micromechanical dispensing device (400) further comprises a sensor (460), the sensor (460) arranged to form a sensor signal (463) responsive to an atmospheric substance (480) and to communicate the sensor signal (463) to the system controller (510).

In a further embodiment, in the system to dispense a plurality of fluids into an atmosphere (500) the system controller (510) is arranged to actuate the micromechanical dispensing device (400) in response to the sensor signal (463).

In one embodiment, the system to dispense a plurality of fluids into an atmosphere (500) further comprises a communication means (540), the communication means comprising a wireless network (540).

Thus, there has been described the fifth aspect of the invention, namely, a micromechanical dispensing device to dispense one or more fluids into an atmosphere (600), the micromechanical dispensing device (600) comprising a micromechanical dispensing mechanism (610), the micromechanical dispensing mechanism (610) fluidly connected to a plurality of fluid reservoirs (620, 621, 622); and further comprising a valve (665), the valve arranged to selectively couple each fluid reservoir of the plurality of fluid reservoirs (620, 621, 622) to the micromechanical dispensing mechanism (610); and, the micromechanical dispensing device (600) further comprising a micromechanical dispensing device controller (640), the micromechanical dispensing device controller (640) arranged to communicate with the micromechanical dispensing mechanism (610) and the valve (665).

In one embodiment, in the micromechanical dispensing device to dispense one or more fluids into an atmosphere (600), the micromechanical dispensing mechanism (610) further comprises an electrostatically-driven membrane, an electrostatically-actuated piston, a magnetically-actuated membrane, a thermally-actuated paddle vane or a ballistic aerosol dispensing mechanism.

In one embodiment, in the micromechanical dispensing device to dispense one or more fluids into an atmosphere (600), at least one fluid reservoir (620, 622) contains a fluid (671, 672), the fluid comprising a perfume, pheromone, moisturizer, humectant, miticide, deodorizer, disinfectant, sanitizing agent or insecticide.

In one embodiment, the micromechanical dispensing device to dispense one or more fluids into an atmosphere (600), further comprises a sensor (660), the sensor (660) arranged to form a sensor signal (636) responsive to an atmospheric substance (680) and to communicate the sensor signal (636) to the micromechanical dispensing device controller (640), and the micromechanical dispensing device controller (640) is arranged to actuate the micromechanical dispensing mechanism (610) in response to the sensor signal (636).

In one embodiment, the micromechanical dispensing device to dispense one or more fluids into an atmosphere (600), further comprises a mixing chamber (670), the mixing chamber (670) fluidly interposed between the micromechanical dispensing mechanism (610) and the plurality of fluid reservoirs (620, 621, 622).

Thus, there has been described the sixth aspect of the invention, namely, a micromechanical dispensing device to dispense a fluid into an atmosphere (700) the micromechanical dispensing device (700) comprising a plurality of micromechanical dispensing mechanisms (710, 711, 712), the plurality of micromechanical dispensing mechanisms (710, 711, 712) fluidly connected to a fluid reservoir (720); and, the micromechanical dispensing device (700) further comprising a micromechanical dispensing device controller (740), the micromechanical dispensing device controller (740) arranged to communicate with the plurality of micromechanical dispensing mechanisms (710, 711, 712).

In one embodiment, the micromechanical dispensing device to dispense a fluid into an atmosphere (700), further comprises a port (726) to which the fluid reservoir (720) may be removably, fluidly connected.

In one embodiment, in the micromechanical dispensing device to dispense a fluid into an atmosphere (700), at least one micromechanical dispensing mechanism (710, 711, 712) further comprises an electrostatically-driven membrane, an electrostatically-actuated piston, a magnetically-actuated membrane, a thermally-actuated paddle vane or a ballistic aerosol dispensing mechanism.

In one embodiment, the micromechanical dispensing device to dispense a fluid into an atmosphere (700) further comprises a fluid (771), the fluid comprising a perfume, pheromone, moisturizer, humectant, miticide, deodorizer, disinfectant, sanitizing agent or insecticide.

In one embodiment, the micromechanical dispensing device to dispense a fluid into an atmosphere (700) further comprises a sensor (760), the sensor (760) arranged to form a sensor signal (735) responsive to an atmospheric substance (780) and to communicate the sensor signal (735) to the micromechanical dispensing device controller (740), and the micromechanical dispensing device controller (740), is arranged to actuate the plurality of micromechanical dispensing mechanisms (710, 711, 712) in response to the sensor signal (735).

While various embodiments of a device and system for dispensing fluids into the atmosphere have been described hereinabove, the scope of the invention is defined by the following claims.

What is claimed is:

1. A micromechanical dispensing device to dispense one or more fluids into an atmosphere, the micromechanical dispensing device comprising a micromechanical dispensing mechanism, the micromechanical dispensing mechanism fluidly connected to a plurality of fluid reservoirs; and further comprising a valve, the valve arranged to selectively couple each fluid reservoir of the plurality of fluid reservoirs to the micromechanical dispensing mechanism; and, the micromechanical dispensing device further comprising a micromechanical dispensing device controller, the micromechanical dispensing device controller arranged to communicate with the micromechanical dispensing mechanism and the valve.

2. The micromechanical dispensing device to dispense one or more fluids into an atmosphere of claim 1, wherein the micromechanical dispensing mechanism further comprises an electrostatically-driven membrane, an electrostatically-actuated piston, a magnetically-actuated membrane, a thermally-actuated paddle vane or a ballistic aerosol dispensing mechanism.

3. The micromechanical dispensing device to dispense one or more fluids into an atmosphere of claim 1, wherein at least one fluid reservoir contains a fluid, the fluid comprising a perfume, pheromone, moisturizer, humectant, miticide, deodorizer, disinfectant, sanitizing agent or insecticide.

4. The micromechanical dispensing device to dispense one or more fluids into an atmosphere of claim 1, further comprising a sensor, the sensor arranged to form a sensor signal responsive to an atmospheric substance and to communicate the sensor signal to the micromechanical dispensing device controller, and the micromechanical dispensing device controller is arranged to actuate the micromechanical dispensing mechanism in response to the sensor signal.

5. The micromechanical dispensing device to dispense one or more fluids into an atmosphere of claim 1 further comprising a mixing chamber, the mixing chamber fluidly interposed between the micromechanical dispensing mechanism and the plurality of fluid reservoirs.

6. A micromechanical dispensing device to dispense a fluid into an atmosphere the micromechanical dispensing device comprising a plurality of micromechanical dispensing mechanisms, the plurality of micromechanical dispensing mechanisms fluidly connected to a fluid reservoir; and, the micromechanical dispensing device further comprising a micromechanical dispensing device controller, the micromechanical dispensing device controller arranged to communicate with the plurality of micromechanical dispensing mechanisms.

7. The micromechanical dispensing device to dispense a fluid into an atmosphere of claim 6, further comprising a port to which the fluid reservoir may be removably, fluidly connected.

8. The micromechanical dispensing device to dispense a fluid into an atmosphere of claim 6, wherein at least one micromechanical dispensing mechanism further comprises an electrostatically-driven membrane, an electrostatically-actuated piston, a magnetically-actuated membrane, a thermally-actuated paddle vane or a ballistic aerosol dispensing mechanism.

9. The micromechanical dispensing device to dispense a fluid into an atmosphere of claim 6, wherein the fluid reservoir contains a fluid, the fluid comprising a perfume, pheromone, moisturizer, humectant, miticide, deodorizer, disinfectant, sanitizing agent or insecticide.

10. The micromechanical dispensing device to dispense a fluid into an atmosphere of claim 6, further comprising a sensor, the sensor arranged to form a sensor signal responsive to an atmospheric substance and to communicate the sensor signal to the micromechanical dispensing device controller, and the micromechanical dispensing device controller, is arranged to actuate the plurality of micromechanical dispensing mechanisms in response to the sensor signal.
